(19) United States
(12) Patent Application Publication
(10) Pub. No.: US 2026/0089497 A1
(43) Pub. Date: Mar. 26, 2026

(54) ENCRYPTED WIRELESS NETWORK BEARER

(71) Applicant: T-MOBILE INNOVATIONS LLC, Overland Park, KS (US)

(72) Inventors: Jeffrey Scott Simon, Jr., Issaquah, WA (US); Geoffrey Todd Gibson, Rowlett, TX (US); Gaurav Madan, Issaquah, WA (US)

(21) Appl. No.: 18/896,393

(22) Filed: Sep. 25, 2024

(51) Int. Cl. H04W 12/04

(52) U.S. Cl. CPC H04W 12/04

(57) ABSTRACT

In some examples, a wireless communication network establishes a data bearer through a wireless communication network for a wireless communication device. The wireless communication network restricts communications over the data bearer to network control and encryption establishment. The wireless communication network exchanges cryptography data over the data bearer between the wireless communication device and an external security service. The wireless communication network determines that the wireless communication device and the external security service have established the encryption over the data bearer, and in response, removes the communication restriction from the data bearer. After the communication restriction is removed, the wireless communication network exchanges encrypted data over the data bearer between the wireless communication device and the external security service.

### TECHNICAL BACKGROUND

Wireless communication networks provide wireless data services to wireless communication devices like phones, computers, and other user devices. The wireless data services may include internet-access, data messaging, video conferencing, or some other data communication product. The wireless communication networks comprise wireless access nodes like Wireless Fidelity (WIFI) hotspots, Fifth Generation New Radio (5GNR) cell towers, and satellites in earth orbit. The wireless communication networks further comprise network elements the process network signaling and handle user data like Access and Mobility Management Functions (AMFs) and User Plane Functions (UPFs).

Some wireless communication networks do not use encryption for user data over some of their network data links. Some wireless communication networks have security risks like compromised equipment. The wireless network user may be forced to use a wireless communication network that they cannot completely trust.

### TECHNICAL OVERVIEW

In some examples, a method comprises the following operations. Establish a data bearer through a wireless communication network for a wireless communication device. Restrict communications over the data bearer to network control and encryption establishment. To establish the encryption, exchange cryptography data between the wireless communication device and a security service over the data bearer. The security service may be internal or external to the wireless communication network. Determine that the wireless communication device and the security service have established the encryption over the data bearer, and in response, remove the communication restriction from the data bearer. Exchange encrypted user data over the data bearer between the wireless communication device and the security service.

In some examples, a method comprises the following operations. Authenticate a wireless communication device. In response to the authentication, authorize the wireless communication device to use: a data bearer in a wireless communication network, a DNS tunnel from the data bearer to a DNS server, and a user tunnel from the data bearer to a user data system. The DNS server and/or the user data system may be internal or external to the wireless communication network. In response to the authorization, establish the data bearer in the wireless communication network and establish the DNS tunnel from the data bearer to the DNS server. Exchange encrypted DNS information between the wireless communication device and the DNS server over the data bearer and the DNS tunnel. Receive a network address for the user data system from the wireless communication device, and in response, establish the user tunnel from the data bearer to the user data system. Exchange encrypted user data between the wireless communication device and the user data system over the data bearer and the user tunnel.

In some examples, a wireless communication network comprises a network control system and a wireless access node. The network control system establishes a data bearer through a wireless communication network for a wireless communication device. The network control system restricts communications over the data bearer to network control and encryption establishment. A network element exchanges cryptography data over the data bearer between the wireless communication device and a security service. The security service may be internal or external to the wireless communication network. The network control system determines that the wireless communication device and the security service have established the encryption over the data bearer, and in response, removes the communication restriction from the data bearer. After the communication restriction is removed, the network element exchanges encrypted data over the data bearer between the wireless communication device and the security service.

### DESCRIPTION OF THE DRAWINGS

FIG. 1 illustrates an exemplary wireless communication network to provide a wireless communication device with an encrypted data bearer.

FIG. 2 illustrates an exemplary operation of the wireless communication network to provide the wireless communication device with the encrypted data bearer.

FIG. 3 illustrates an exemplary operation of the wireless communication network to provide the wireless communication device with the encrypted data bearer.

FIG. 4 illustrates exemplary processing circuitry to provide a wireless communication device with an encrypted data bearer.

FIG. 5 illustrates an exemplary wireless communication network to serve a wireless User Equipment (UE) with an encrypted data bearer, encrypted DNS tunnel, and encrypted user tunnel.

FIG. 6 illustrates an exemplary wireless UE in the wireless communication network that serves the wireless UE with an encrypted data bearer, encrypted DNS tunnel, and encrypted user tunnel.

FIG. 7 illustrates an exemplary Fifth Generation New Radio (5GNR) Access Node (AN) in the wireless communication network that serves the wireless UE with an encrypted data bearer, encrypted DNS tunnel, and encrypted user tunnel.

FIG. 8 illustrates an exemplary Wireless Fidelity (WIFI) AN in the wireless communication network that serves the wireless UE with an encrypted data bearer, encrypted DNS tunnel, and encrypted user tunnel.

FIG. 9 illustrates an exemplary Satellite (SAT) AN node and SAT Ground Station (GND) in the wireless communication network that serves the wireless UE with an encrypted data bearer, encrypted DNS tunnel, and encrypted user tunnel.

FIG. 10 illustrates an exemplary Network Function Virtualization Infrastructure (NFVI) in the wireless communication network that serves the wireless UE with an encrypted data bearer, encrypted DNS tunnel, and encrypted user tunnel.

FIG. 11 illustrates the exemplary communication network to serve the wireless UE with an encrypted data bearer, encrypted DNS tunnel, and encrypted user tunnel over the 5GNR AN.

FIGS. 12-13 illustrate an exemplary operation of the wireless communication network to serve the wireless UE with an encrypted data bearer, encrypted DNS tunnel, and encrypted user tunnel over the 5GNR AN.

FIG. 14 illustrates the exemplary communication network to serve the wireless UE with an encrypted data bearer, encrypted DNS tunnel, and encrypted user tunnel over the WIFI AN.

FIGS. 15-16 illustrate an exemplary operation of the wireless communication network to serve the wireless UE with an encrypted data bearer, encrypted DNS tunnel, and encrypted user tunnel over the WIFI AN.

FIG. 17 illustrates the exemplary wireless communication network to serve the wireless UE with an encrypted data bearer, encrypted DNS tunnel, and encrypted user tunnel over the SAT AN.

FIGS. 18-19 illustrate an exemplary operation of the wireless communication network to serve the wireless UE with an encrypted data bearer, encrypted DNS tunnel, and encrypted user tunnel over the SAT AN.

### DETAILED DESCRIPTION

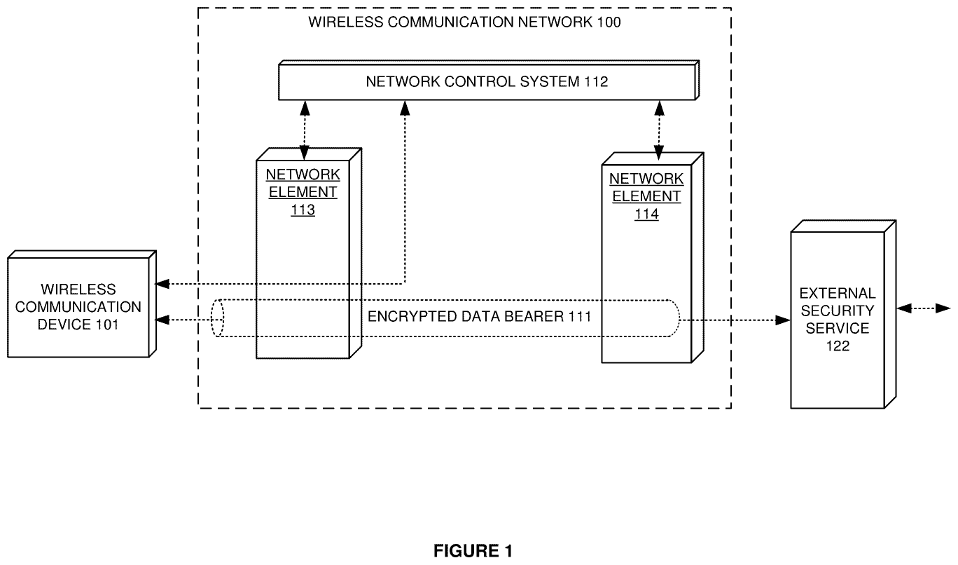

FIG. 1 illustrates exemplary wireless communication network 100 to provide wireless communication device 101 with encrypted data bearer 111. Wireless communication network 100 comprises network control system 112, and network elements 113-114. Network elements 113-114 serve encrypted data bearer 111 to wireless communication device 101 under the control of network control system 112. Wireless communication device 101 and external security service 122 exchange encrypted user data over encrypted data bearer 111. External security service 122 may comprise a communication hub for wireless communication device 101. For example, external security service 122 may exchange user data between wireless communication device 101 and other data systems like phones, computers, watches, vehicles, drones, and the like. In this example, external security service 122 is external to and not a part of wireless communication network 100. In other examples, the security service may be internal to and a part of wireless communication network 100.

In operation, network control system 112 establishes encrypted data bearer 111 through wireless communication network 100 for wireless communication device 101. Initially, network control system 112 restricts communications over encrypted data bearer 111 to network control and encryption establishment. Network control system 112 may also restrict communications over encrypted data bearer 111 to select destinations by destination name, address, or some other information. The network control comprises network signaling that directs the operation of wireless communication network 100. The encryption establishment comprises communications between data systems to perform authentication and crypto-key generation. Network control system 112 may instruct network element 113 and/or network element 114 to block all communications with wireless communication device 101 except for signaling with wireless communication network 100 and encryption set-up messaging with external security service 122.

Network elements 113-114 exchange cryptography data over encrypted data bearer 111 between wireless communication device 101 and external security service 122 to help establish the encryption. The cryptography data exchange may use Domain Name System over Hyper-Text Transfer Protocol Secure (DoH), Datagram Transport Layer Security (DTLS), or some other security protocol. Network control system 112 determines that wireless communication device 101 and external security service 122 have established the encryption over encrypted data bearer 111, and in response, network control system 112 removes the communication restriction from encrypted data bearer 111. After the communication restriction is removed, network elements 113-114 exchange encrypted user data over encrypted data bearer 111 between wireless communication device 101 and external security service 122. For example, wireless communication device 101 may generate and encrypt video data for transfer to external security service 122. Wireless communication device 101 may then transfer the encrypted video data to external security service 122 over encrypted data bearer 111 and an external network like a public internet. Wireless communication network 100 does not decrypt or modify the encrypted video data. Wireless communication device 101 may perform the above operations automatically upon attachment to wireless communication network 100—and without user control or instruction.

In some examples, the encryption by wireless communication device 101 and external security service 122 allows network elements 113-114 to omit their own encryption for wireless communication device 101. For example, wireless communication device 101 and network element 113 may omit the over-the-air encryption that is typically used between a user device and a wireless access node. Thus, overlapping layers of encryption may be reduced to a single layer of encryption between wireless communication device 101 and external security service 122.

In some examples, network elements 113-114 transfer translation data over the data bearer between wireless communication device 101 and an external translation system like a Domain Name Service (DNS) server. The translation data transferred from the wireless communication device 101 to the external translation system indicates a name for external security service 122. The external translation system translates the name into a network address for external security service 122. The translation data transferred from the external translation system to wireless communication device 101 indicates the network address for external security service 122. Wireless communication device 101 uses the network address to establish encryption with external security service 122 over encrypted data tunnel 111. To establish the encryption, wireless communication device 101 and external security service 122 may use Internet Protocol Security (IP SEC), Virtual Private Network (VPN), or some other security protocol. Wireless communication device 101 uses the network address to exchange encrypted data with external security service 122 over encrypted data bearer 111.

The translation data from the external translation system to wireless communication device 101 may include a digital certificate. Wireless communication device 101 validates the digital certificate, and in response to the validation, uses the network address from the external translation system to establish the encryption and to exchange the encrypted user data with external security service 122 over encrypted data bearer 111. Wireless communication device 101 would not use the network address without the valid digital certificate. The translation data from wireless communication device 101 to the external translation system may include a digital certificate. The external translation system validates the digital certificate, and in response to the validation, translates the name for external security service 122 into the network address for external security service 122. The external translation system would not translate the name into the network address without a valid digital certificate from wireless communication device 101.

In some examples, network control system 112 receives slice information from wireless communication device 101. Network control system 112 establishes encrypted data bearer 111 through a wireless network slice based on the slice information. Initially, network control system 112 restricts the communications over encrypted data bearer 111 through the wireless network slice. Network elements 113-114 exchange cryptography data over encrypted data bearer 111 through the wireless network slice. Network control system 112 determines that wireless communication device 101 and external security service 122 have established encryption over encrypted data bearer 111 through the wireless network slice. Network control system 112 removes the communication restriction from encrypted data bearer 111 through the wireless network slice. After the communication restriction is removed, network elements 113-114 exchange the encrypted user data over encrypted data bearer 111 through the wireless network slice.

In some examples, network control system 111 establishes the data bearer for a user application in wireless communication device 101. Initially, network control system 112 restricts the communications for the user application. After the communication restriction is removed, wireless access node 101 exchanges the encrypted data over encrypted data bearer 111 for the user application. Network control system 112 may establish encrypted data bearer 111 for a distributed Application (dAPP) in both wireless communication device 101 and external security service 122. Initially, network control system 112 restricts the communications over encrypted data bearer 111 between the dAPP in wireless communication device 101 and the dAPP in external security service 122. After the communication restriction is removed, network elements 113-114 exchange encrypted user data over encrypted data bearer 111 between the dAPP in wireless communication device 101 and the dAPP in external security service 122.

In some examples, network control system 112 and network element 114 establish an external data tunnel from encrypted data bearer 111 to an external Domain Name System (DNS). Wireless communication device 101 exchanges encrypted DNS information with the external DNS over encrypted data bearer 111 and the external DNS tunnel. Network control system 112 and network element 114 also establish an external data tunnel from encrypted data bearer 111 to external security service 122. Wireless communication device 101 exchanges the encrypted user data with external security service 122 over the external data tunnel.

Wireless communication device 101 comprises a phone, watch, computer, vehicle, sensor, and/or some other user apparatus with wireless communication components. In some examples, wireless communication device 101 has a user application or a dAPP that uses encrypted data bearer 111 to communicate with external security service 122. Wireless communication device 101 may include a Trust Platform Module (TPM) that interacts with a TPM in external security service 122 and/or an external translation system. The TPMs perform TPM authentication, hardware/software integrity attestation, and cryptographic key generation. For example, the TPM in wireless communication device 101 may attest to the integrity of the software in device 101 that notifies network control system 112 when encryption over data bearer 111 is established.

Wireless communication device 101 may add headers to packet communications with external security service 122 that indicate Subscriber Identity Module (SIM) information, integrity data, geographic location, network access, and other information. Wireless communication device 101 wirelessly communicates using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and satellite data communications.

Network elements 113-114 comprises wireless access nodes, Interworking Functions (IWFs), User-Plane Functions (UPFs), packet routers, application servers and/or some other user-plane apparatus. The wireless access nodes might comprise 5GNR gNodeBs, WIFI hotspots, earth satellites and ground stations, or some other data communication apparatus with wireless communication components. Network control system 112 comprises an Access and Mobility Function (AMF), Session Management Function (SMF), and/or some other control-plane network element. External security service 122 comprises a computer system, phone, vehicle, and/or some other data communication components.

Wireless communication device 101, network control system 112, network elements 113-114, and external security service 122 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of wireless communication network 100 as described herein.

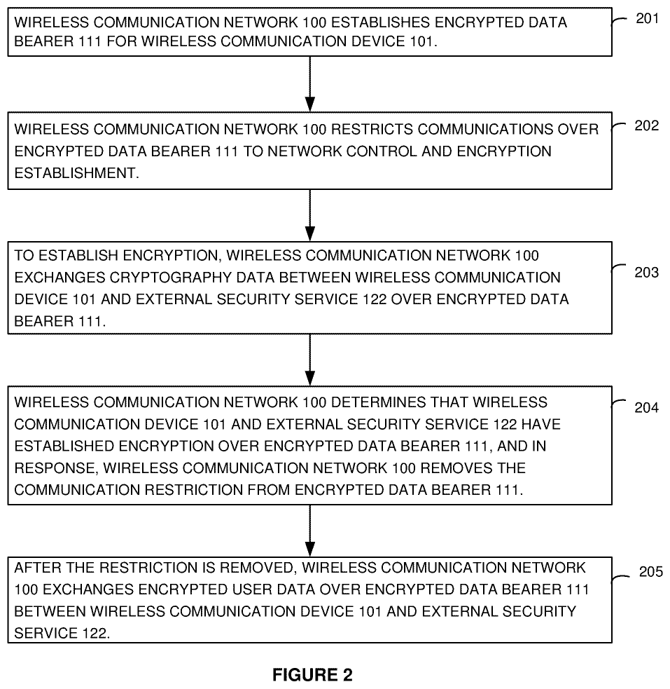

FIG. 2 illustrates an exemplary operation of wireless communication network 100 to provide wireless communication device 101 with encrypted data bearer 111. The operation may differ in other examples. Wireless communication network 100 establishes encrypted data bearer 111 for wireless communication device 101 (201). Wireless communication network 100 restricts communications over encrypted data bearer 111 to network control and encryption establishment (202). To establish encryption, wireless communication network 100 exchanges cryptography data between wireless communication device 101 and external security service 122 over encrypted data bearer 111 (203). Wireless communication network 100 determines that wireless communication device 101 and external security service 122 have established encryption over encrypted data bearer 111, and in response, wireless communication network 100 removes the communication restriction from encrypted data bearer 111 (204). After the restriction is removed, wireless communication network 100 exchanges encrypted user data over encrypted data bearer 111 between wireless communication device 101 and external security service 122 (205).

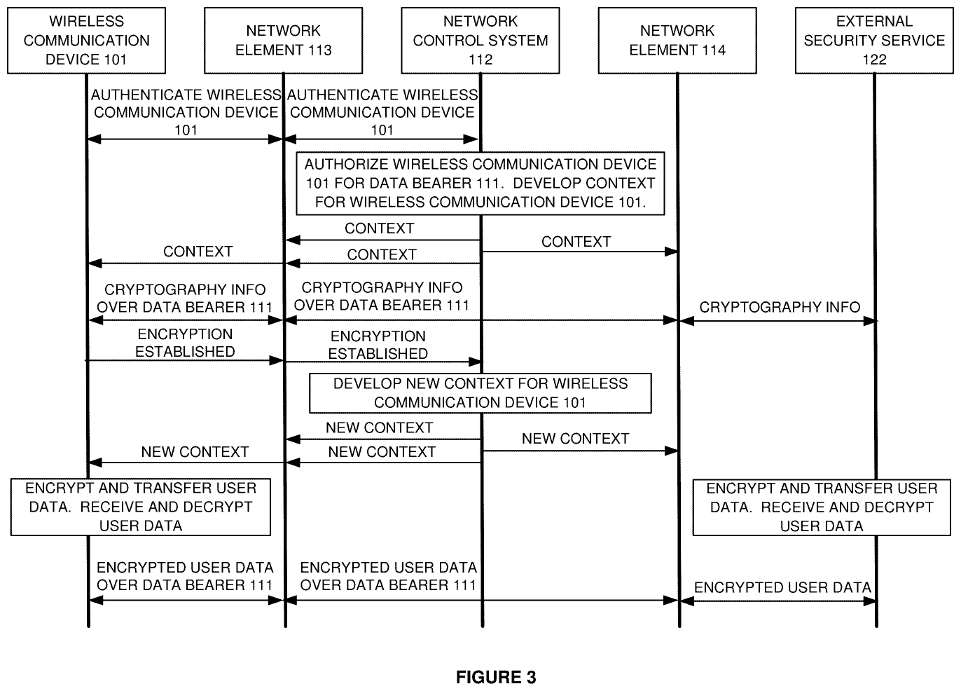

FIG. 3 illustrates an exemplary operation of wireless communication network 100 to provide wireless communication device 101 with encrypted data bearer 111. The operation may differ in other examples. Wireless communication device 101 and network control system 112 exchange authentication information over network element 113, and in response, network control system 112 authenticates wireless communication device 101. In response to the authentication, network control system 112 authorizes wireless communication device 101 to use encrypted data bearer 111. In response to the authorization, network control system 112 develops the context for wireless communication device 101 that includes an instruction to restrict the use of encrypted data bearer 111 to network control and encryption establishment. Network control system 112 signals the context to network elements 113-114. Network control system 112 signals the context to wireless communication device 101 over network element 113. Based on the context, wireless communication device 101 and external security service 122 exchange cryptography information over encrypted data bearer 111 and an external data link.

Wireless communication device 101 signals network control system 112 over network element 113 that encryption has been established with eternal security service 122 over data bearer 111. For example, a TPM in wireless communication device 101 may authenticate itself, attest to the integrity of software in device 101, and provide cryptographic keys to establish the encryption over data bearer 111. The attested software in wireless communication device 101 reports the encryption to network control system 112. In response to the encryption, network control system 112 develops new context for wireless communication device 101 that includes an instruction to remove the restriction on encrypted data bearer 111. Network control system 112 signals the new context to network elements 113-114. Network control system 112 signals the new context to wireless communication device 101 over network element 113. Based on the new context, wireless communication device 101 and external security service 122 exchange encrypted user data over encrypted data bearer 111 and the external data link.

Advantageously, wireless communication network 100 implements end-to-end encryption for user data through network 100. Moreover, wireless communication network 100 mitigates network security risks for its users. Thus, wireless communication network 100 represents a zero-trust network that efficiently and effectively serves wireless communication device 101.

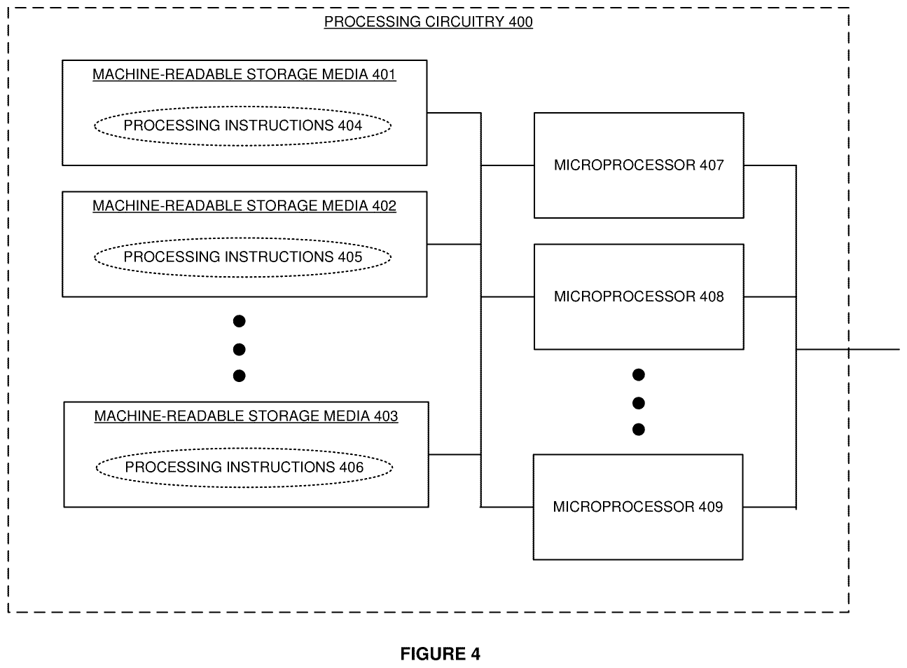

FIG. 4 illustrates exemplary processing circuitry to provide a wireless communication device with an encrypted data bearer. Processing circuitry 400 comprises an example of wireless communication device 101, data bearer 111, and network control system 112, although device 101, bearer 111, and/or system 112 may differ. Processing circuitry 400 comprises machine-readable storage media 401-403 and microprocessors 407-409 that are communicatively coupled. Machine-readable storage media 401-403 store processing instructions 404-406 in a non-transitory manner. Microprocessors 407-409 comprise DSPs, CPUs, GPUs, ASICs, and/or some other data processing hardware. Machine-readable storage media 401-403 comprises RAM, flash circuitry, disk drives, and/or some other type of data storage apparatus. Microprocessors 407-409 retrieve processing instructions 404-406 from non-transitory machine-readable storage media 401-403. Microprocessors 407-409 execute processing instructions 404-406 to provide wireless communication devices with encrypted data bearers as described above for wireless communication network 100 and as described below for wireless communication network 500. The amount of storage media, microprocessors, processing instructions that are shown in FIG. 4 may vary in other examples.

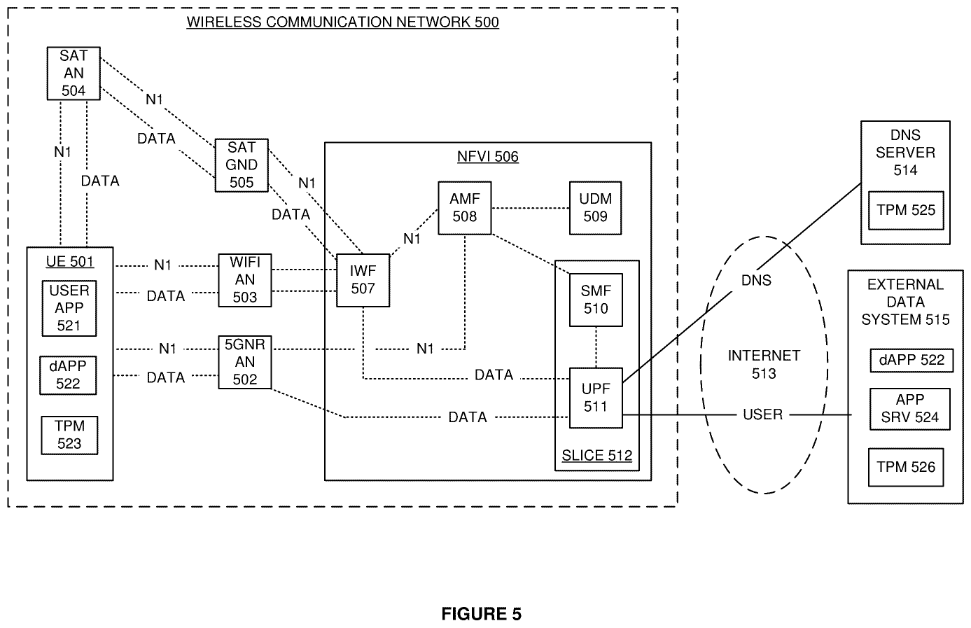

FIG. 5 illustrates exemplary wireless communication network 500 to serve wireless User Equipment (UE) 501 with an encrypted data bearer, encrypted Domain Name System (DNS) tunnel, and encrypted user tunnel. Wireless communication network 500 comprises an example of wireless communication network 100 and processing circuitry 400, although network 100 and circuitry 400 may differ. Wireless communication network 500 comprises User Equipment (UE) 501, Fifth Generation New Radio (5GNR) Access Node (AN) 502, Wireless Fidelity (WIFI) AN 503, earth satellite (SAT) AN 504, satellite ground station (SAT GND) 505, and Network Function Virtualization Infrastructure (NFVI) 506. NFVI 506 comprises Interworking Function (IWF) 507, Access and Mobility Management Function (AMF) 508, Unified Data Management (UDM) 509, Session Management Function (SMF) 510, and User Plane Function (UPF) 511.

UE 501 comprises User Application (APP) 521, distributed Application (dAPP) 522, and Trusted Platform Module (TPM) 523. DNS server 514 comprises TPM 525. External data system 515 comprises dAPP 522, APP Server (SRV) 524, and TPM 526. SMF 510 and UPF 511 comprise wireless network slice 512. UPF 511 is coupled to external DNS server 514 by an external DNS tunnel over internet 513. UPF 511 is coupled to external data system 515 by an external user tunnel over internet 513. In this example, the DNS tunnel, DNS server 514, user tunnel, and data system 515 are external to and not a part of wireless communication network 500. In other examples, the DNS tunnel, DNS server 514, user tunnel, and data system 515 are internal to and a part of wireless communication network 500.

External data system 515 may comprise a communication hub for UE 501 to other data systems. External data system 515 also comprises dAPP 522 which interacts with dAPP 522 in UE 501. External data system 515 comprises APP SRV 524 which serves user application 521 in UE 501. In external data system, APP SRV 524 or dAPP 522 may function as a communication hub for UE 501 to other data systems.

The encryption by wireless UE 501, DNS server 514, and external data system 515 allows ANs 502-504, IWF 507, and UPF 511 to omit their own encryption for wireless UE 501. For example, wireless communication device 101 and 5GNR AN 502 may omit the over-the-air encryption that is typically used between a UE and a 5GNR access node.

For clarity, a single IWF 507 is depicted as serving both WIFI AN 503 and SAT GND 505 but different IWFs could be used—IWF 507 for WIFI AN 503 and another IWF for SAT GND 505. For clarity, a single UPF 511 is depicted as serving both 5GNR AN 502 and IWF 507 but different UPFs could be used—UPF 512 for 5GNR AN 502, another UPF for IWF 507, and another UPF for the IWF that serves SAT GND 505.

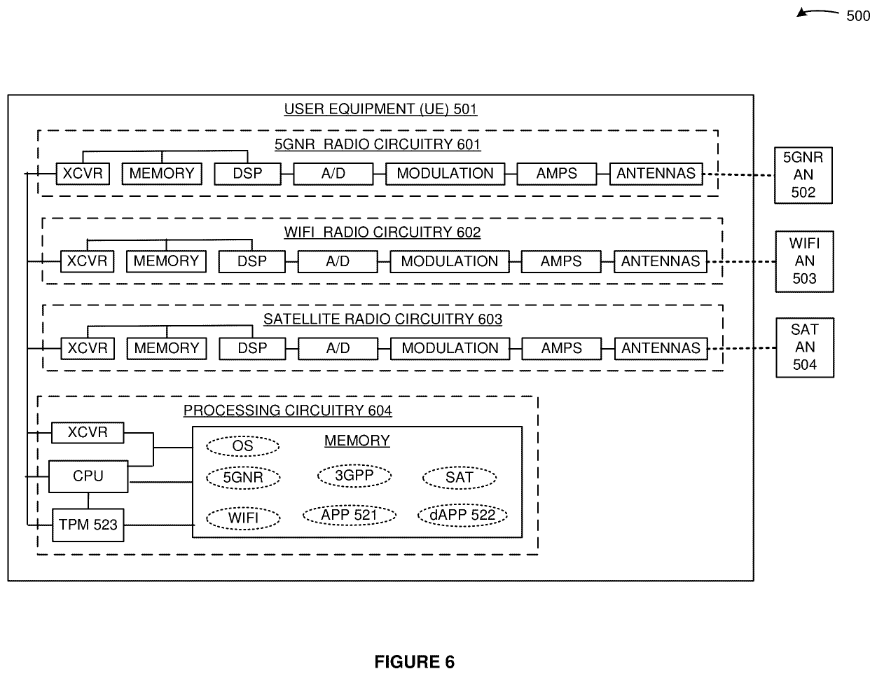

FIG. 6 illustrates exemplary wireless UE 501 in wireless communication network 599 that serves wireless UE 501 with the encrypted data bearer, encrypted DNS tunnel, and encrypted user tunnel. UE 501 comprises an example of wireless communication device 101 and processing circuitry 400, although device 101 and circuitry 400 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 5GNR Application (5GNR), 3GPP Application (3GPP), WIFI Application (WIFI), Satellite Application (SAT), APP 521, and dAPP 522. The antennas in radio circuitry 601-603 exchange wireless signals with ANs 502-504. Transceivers in radio circuitry 601-603 are coupled to transceivers in processing circuitry 604. In processing circuitry 604, the one or more CPUs retrieve the software from the one or more memories and execute the software to direct the operation of UE 501 as described herein.

Processing circuitry 604 also comprises Trust Platform Module (TPM) 523. TPM 523 comprises a cryptography microprocessor and software. TPM 523 provides TPM authentication, hardware/software integrity attestation, and cryptographic key generation and storage. UE 501 establishes the encryption with DNS 514 and with external data system 515. UE 501 notifies AMF 508 when encryption over the data bearer has been established. For example, TPM 523 may authenticate itself with AMF 508 and attest to the integrity of the software in UE 501 that establishes and indicates the encryption. The attested software may provide a digital certificate to further validate the notification.

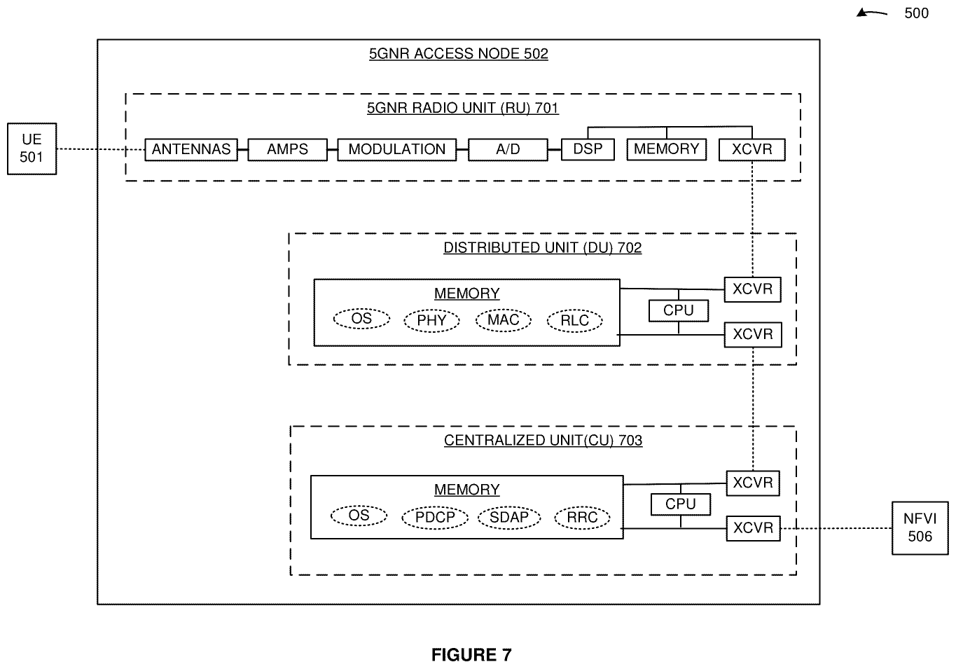

FIG. 7 illustrates exemplary Fifth Generation New Radio Access Node (5GNR AN) 502 in wireless communication network 500 that serves wireless UE 501 with the encrypted data bearer, encrypted DNS tunnel, and encrypted user tunnel. 5GNR AN 502 comprises an example of network elements 113-114, network control system 112, and processing circuitry 400, although elements 113-114, system 112, and circuitry 400 may differ. 5GNR AN 502 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. DU 702 comprises memory, CPU, user interfaces and components, and transceivers that are coupled over bus circuitry. The memory in DU 702 stores operating system and 5GNR network applications for Physical Layer (PHY), Media Access Control (MAC), and Radio Link Control (RLC). CU 703 comprises memory, CPU, and transceivers that are coupled over bus circuitry. The memory in CU 703 stores an operating system and 5GNR network applications for Packet Data Convergence Protocol (PDCP), Service Data Adaption Protocol (SDAP), and Radio Resource Control (RRC). The antennas in 5GNR RU 701 are wirelessly coupled to UE 501 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 506. The DSP and CPU in RU 701, DU 702, and CU 703 execute the radio applications, operating systems, and network applications to exchange data and signaling between UE 501 and NFVI 506 as described herein.

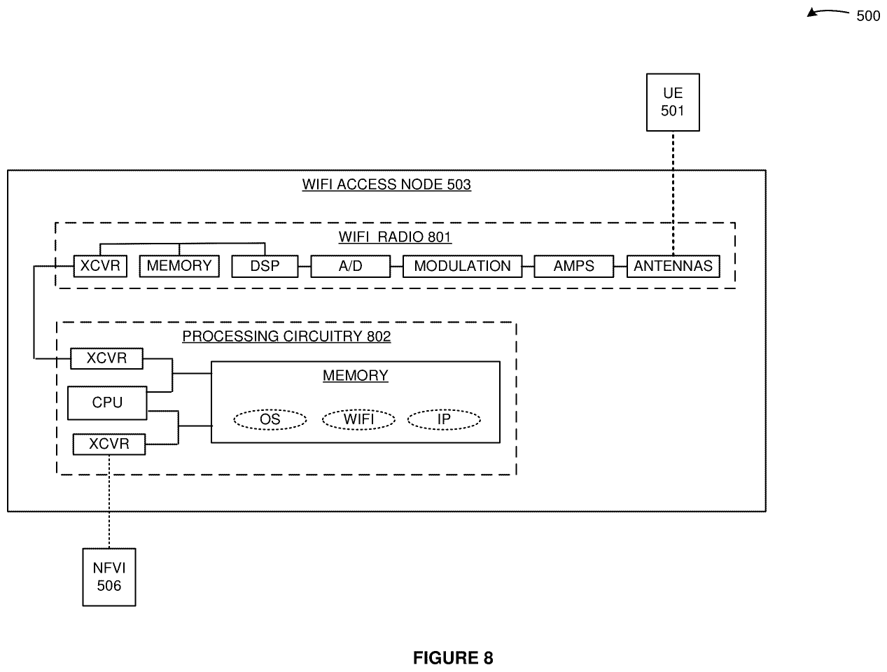

FIG. 8 illustrates exemplary Wireless Fidelity Access Node (WIFI AN) 503 in wireless communication network 500 that serves wireless UE 501 with the encrypted data bearer, encrypted DNS tunnel, and encrypted user tunnel. WIFI AN 503 comprises an example of network control system 112, network elements 113-114, and processing circuitry 400, although system 112, elements 113-114, and circuitry 400 may differ. WIFI AN 503 comprises WIFI radio 801 and processing circuitry 802. Radio 801 comprises antennas, amplifiers, filters, modulation, analog-to-digital interfaces, DSPs, memories, and transceivers that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio 801 exchange WIFI signals with UE 501. Transceivers in radio 801 are coupled to transceivers in processing circuitry 802. Transceivers in processing circuitry 802 are coupled to transceivers in NFVI 506. In processing circuitry 802, the one or more CPUs retrieve the software from the one or more memories and execute the software to exchange data and signaling between UE 501 and NFVI 506 as described herein.

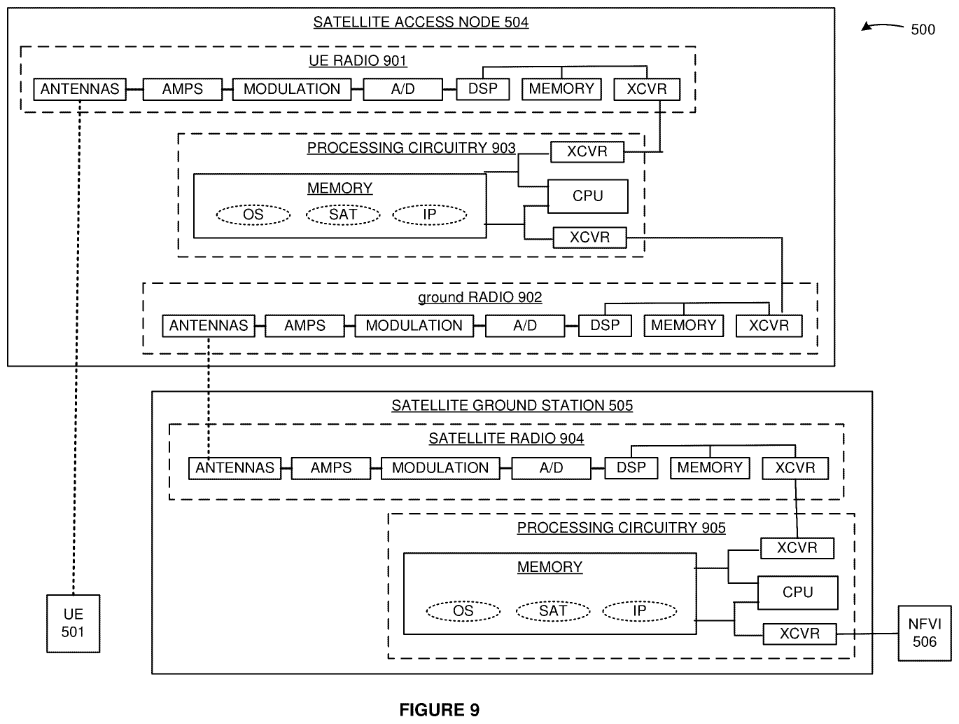

FIG. 9 illustrates exemplary Satellite Access Node (SAT AN) 503 and Satellite Ground Station (SAT GND) 504 in wireless communication network 500 that serves wireless UE 501 with the encrypted data bearer, encrypted DNS tunnel, and encrypted user tunnel. SAT AN 504 and SAT GND 505 comprise examples of network control system 112, network elements 113-114, and processing circuitry 400, although system 112, elements 113-114, and circuitry 400 may differ. SAT AN 504 comprises UE radio 901, ground radio 902 and processing circuitry 903. SAT GND 505 comprises satellite radio 904 and processing circuitry 905. Radios 901-902 and 904 comprise antennas, amplifiers, filters, modulation, analog-to-digital interfaces, DSPs, memories, and transceivers that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio 901 exchange satellite signals with UE 501. Transceivers in UE radio 901 are coupled to transceivers in processing circuitry 903. Transceivers in processing circuitry 903 are coupled to transceivers in ground radio 902. The antennas in ground radio 902 exchange satellite signals with antennas in satellite radio 904, and the antennas in satellite radio 904 exchange the satellite signals with ground radio 902. Transceivers in satellite radio 904 are coupled to transceivers in processing circuitry 905. Transceivers in processing circuitry 905 are coupled to transceivers in NFVI 506. In processing circuitry 903 and 905, the one or more CPUs retrieve the software from the one or more memories and execute the software to exchange data and signaling between UE 501 and NFVI 506 as described herein.

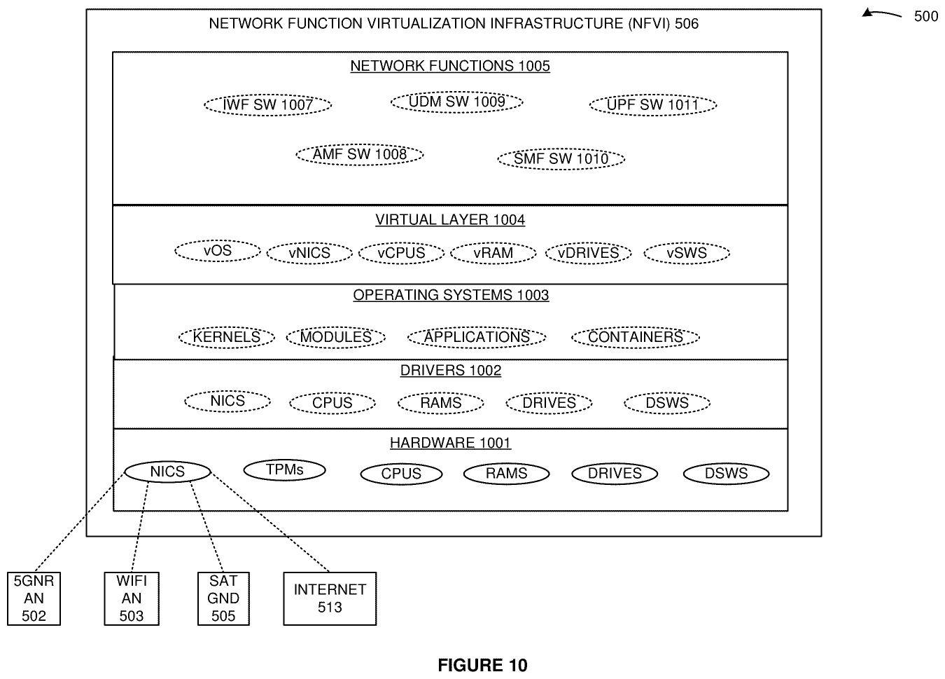

FIG. 10 illustrates exemplary Network Function Virtualization Infrastructure (NFVI) 506 in wireless communication network 500 that serves wireless UE 501 with the encrypted data bearer, encrypted DNS tunnel, and encrypted user tunnel. NFVI 506 comprises an example of network control system 112, network elements 113-114, and processing circuitry 400, although system 112, elements 113-114, and circuitry 400 may differ. NFVI 506 comprises hardware 1001, hardware drivers 1002, operating systems 1003, virtual layer 1004, and network functions 1005. Hardware 1001 comprises Network Interface Cards (NICS), TPMs, CPUs, RAM, Flash/Disk Drives (DRIVES), and Data Switches (DSWS). Hardware drivers 1002 comprise software that is resident in the NICS, TPMs, CPUs, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises IWF SW 1007, AMF SW 1008, UDM SW 1009, SMF SW 1010, and UPF SW 1011. The NICS in hardware 1001 are coupled to ANs 502-503, SAT GND 505, and internet 513. Hardware 1001 executes hardware drivers 1002, operating systems 1003, virtual layer 1004, and network functions 1005 to form and operate IWF 507, AMF 508, UDM 509, SMF 510, and UPF 511 as described herein. NFVI 506 comprises one or more microprocessors and one or more non-transitory machine-readable storage media that store processing instructions that direct NFVI 506 to exchange data and signaling between ANs 502-503, SAT GND 505, and internet 513 as described herein. NFVI 506 may be located at a single site or be distributed across multiple geographic areas.

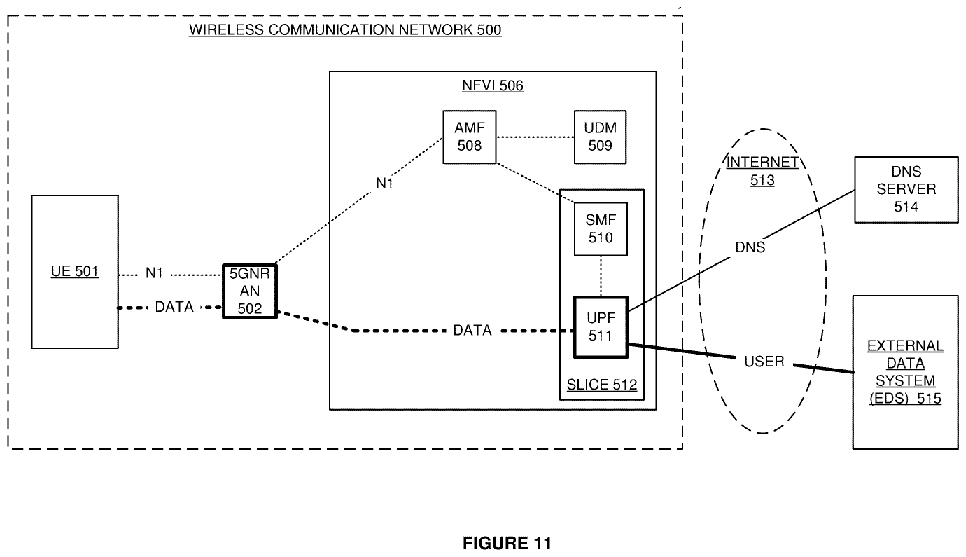

FIG. 11 illustrates exemplary wireless communication network 500 to serve wireless UE 501 with the encrypted data bearer, encrypted DNS tunnel, and encrypted user tunnel over 5GNR AN 502. UE 501 and AMF 508 exchange N1 signaling over an N1 signaling link that traverses 5GNR AN 502. UE 501 and UPF 511 exchange encrypted DNS information over a data bearer (DATA) that traverses 5GNR AN 502. UPF 511 and DNS server 514 exchange the encrypted DNS information over an external DNS tunnel (DNS) that traverses internet 513. The external DNS tunnel encapsulates the encrypted DNS information. The external DNS tunnel may be omitted in some examples. DNS server 514 may be internal to wireless communication network 500 in some examples. UE 501 and UPF 511 exchange encrypted user data over the data bearer that traverses 5GNR AN 502. UPF 511 and External Data System (EDS) 515 exchange the encrypted user data over an external user tunnel (USER) that traverses internet 513. The external user tunnel encapsulates the encrypted user data. The external user tunnel may be omitted in some examples. EDS 515 may be internal to wireless communication network 500 in some examples. UE 501 and EDS 515 exchange the encrypted user data over wireless network slice 512 that comprises the data bearer. UE 501 and UPF 511 implement integrity protection to ensure that the encrypted DNS information and the encrypted user data are not tampered with in wireless communication network 500. UE 501 or UPF 511 may implement integrity protection with DNS 514 and EDS 515 for the external DNS tunnel and the external user tunnel.

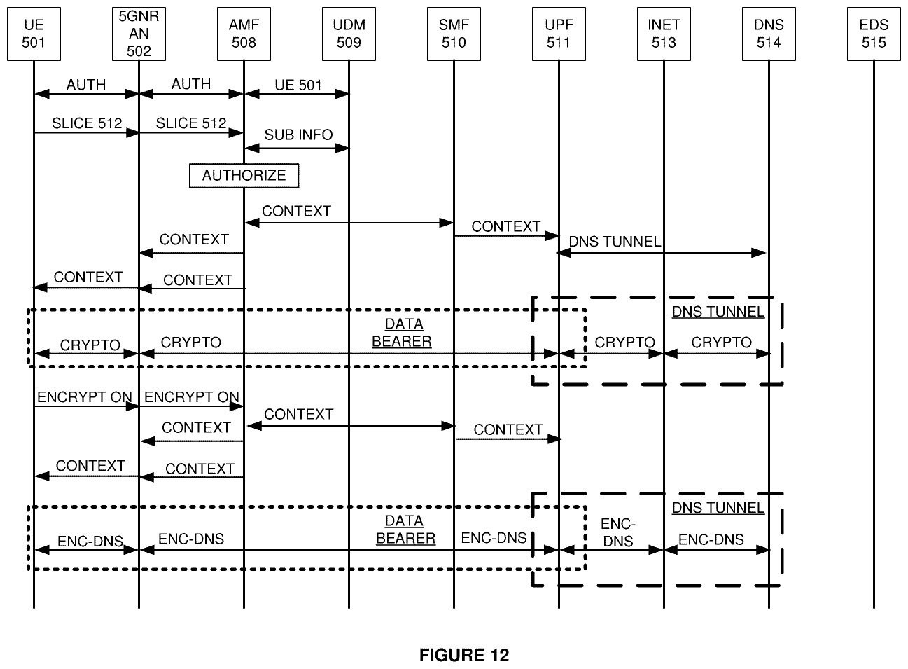

FIG. 12 illustrates an exemplary operation of wireless communication network 500 to serve wireless UE 501 with the encrypted data bearer, encrypted DNS tunnel, and encrypted user tunnel over 5GNR AN 502. The operation may differ in other examples. To authenticate UE 501, AMF 508 and UE 501 exchange authentication signaling (AUTH) over 5GNR AN 502. AMF 508 retrieves authentication information for UE 501 from UDM 509. AMF 508 authenticates UE 501 based on the authentication information and the signaling. In particular, AMF 508 transfers an authentication challenge to UE 501 over 5GNR AN 502. UE 501 uses a secret key to respond to AMF 508, and AMF 508 verifies this secret key based on the authentication information.

After authentication, UE 501 indicates wireless network slice 512 to AMF 508 over 5GNR AN 502. UE 501 may indicate slice 512 by indicating a slice type or some other slice information. AMF 508 retrieves subscriber information (SUB INFO) for UE 501 from UDM 509. AMF 508 authorizes UE 501 for slice 512 based on the subscriber information. The subscriber information for slice 512 indicates the following data links to give UE 501: 1) a data bearer between UE 501 and UPF 511, 2) an external DNS tunnel between UPF 511 and external DNS server 514, and 3) an external user tunnel between UPF 511 and an internet address for EDS 515 to be supplied by UE 501.

AMF 508 and SMF 511 interact to develop context for the data bearer, the external DNS tunnel, and the external user tunnel based on the subscriber information. The context includes network addresses, service qualities, and the like. The context for the data bearer restricts initial use to network control and encryption establishment. The restriction is removed for DNS information when encryption is established over the data bearer and the external DNS tunnel. The restriction is removed for user data when encryption is established over the data bearer and the external user tunnel. SMF 511 transfers context to UPF 511. AMF 508 transfers context to 5GNR AN 502. AMF 508 transfers context to UE 501 over 5GNR AN 502. UE 501 and 5GNR AN 502 establish part of the data bearer based on the context. 5GNR AN 502 and UPF 511 establish the other part of the data bearer based on the context. UPF 511 establishes the external DNS tunnel with external DNS server 514 over internet 513 based on the context.

The subscriber information for UE 501 may indicate DNS server 514 for UE 501 and/or dAPP 522. Alternatively, UE 501 may indicate DNS server 514 to AMF 508, and AMF 508 may authorize DNS server 514 based on the subscriber information for UE 501. For example, the subscriber information may include a list of allowable DNS names that network 500 can translate into the appropriate DNS addresses, and UE 501 may provide one of those allowed names. The context carries the DNS address to UPF 511 for DNS tunnel establishment.

Except for network control and encryption establishment, 5GNR AN 502 and/or UPF 511 block other communications over the data bearer per the context. UE 501 and DNS server 514 exchange cryptography information (CRYPTO) over the data bearer and the external DNS tunnel to establish cryptography keys. UE 501 establishes the encryption with DNS server 514. In UE 501, TPM 523 provides the keys to establish the encryption with DNS server 514. UE 501 signals AMF 508 over 5GNR AN 502 to indicate that encryption has been established over the data bearer and the external DNS tunnel. AMF 508 validates the encryption notification, and AMF 508 does not remove the restriction unless the notification is valid. In UE 501, TPM 523 may provide a hash of its hardware identifier, and AMF 508 may authenticate TPM 523 based on the hash. TPM 523 monitors boot records and can attest to the integrity of the software in UE 501. The encryption notification is from this attested software, and AMF 508 validates the encryption indication because the attested software provided the notification. AMF 508 does not remove the restriction unless the encryption notification is valid.

AMF 508 and SMF 511 interact to develop additional context that removes the communication restriction from the data bearer when using the external DNS tunnel. SMF 511 transfers the additional context to UPF 511. AMF 508 transfers additional the context to 5GNR AN 502. AMF 508 transfers the additional context to UE 501 over 5GNR AN 502.

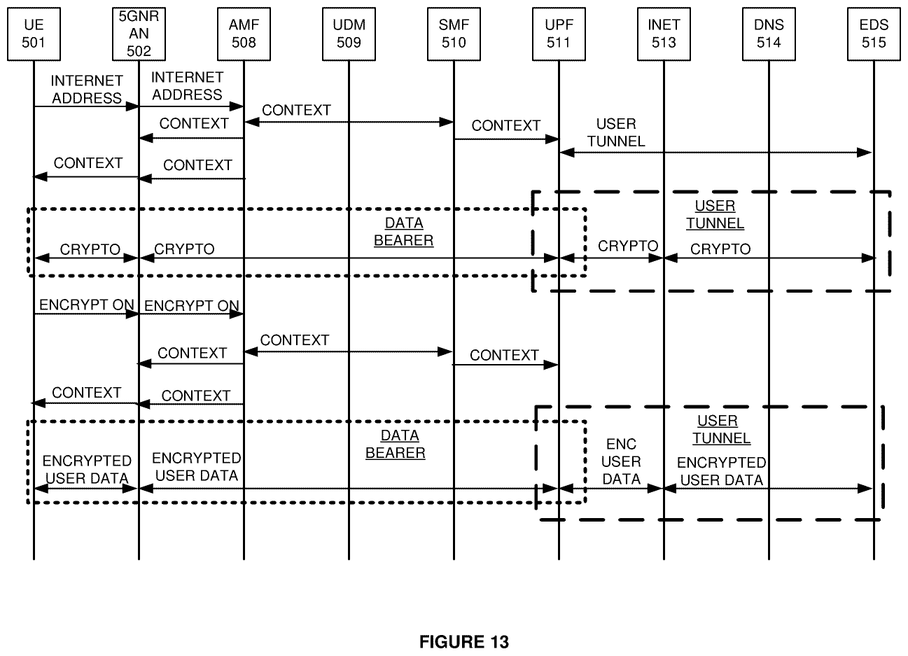

In response to the additional context, UE 501 and DNS server 514 exchange encrypted DNS information (ENC-DNS). In particular, UE 501 encrypts a domain name for EDS 515 and transfers the encrypted domain name to DNS server 514 over the data bearer and the external DNS tunnel that traverse 5GNR 502, UPF 511, and internet 513. DNS server 514 decrypts the encrypted domain name. DNS server 514 translates the domain name into an internet address for EDS 515. DNS server 514 encrypts and transfers the internet address and a digital certificate to UE 501 over the external DNS tunnel and the data bearer that traverse internet 513, UPF 511, and 5GNR AN 502. UE 501 receives and decrypts the encrypted internet address and the digital certificate. UE 501 validates the digital certificate with a public key for external DNS server 514 and only uses the internet address when the digital certificate is valid. The operation continues on FIG. 13 below.

FIG. 13 further illustrates the exemplary operation of wireless communication network 500 to serve wireless UE 501 with the encrypted data bearer, encrypted DNS tunnel, and encrypted user tunnel over 5GNR AN 502. The operation continues from FIG. 12 above and may differ in other examples. UE 501 indicates the internet address from DNS 514 to AMF 508 over 5GNR AN 502. UE 501 may also provide the digital certificate from DNS 514. AMF 508 validates the internet address by validating a digital certificate. AMF 508 may also validate the internet address by verifying the attestation of integrity from TPM 523 for the software in UE 501 that provides the internet address. AMF 508 does not use the internet address unless the indication is valid. AMF 508 and SMF 511 interact to develop context for the data bearer and the external user tunnel. SMF 511 transfers context which includes the internet address to UPF 511. AMF 508 transfers context to 5GNR AN 502. AMF 508 transfers context to UE 501 over 5GNR AN 502. UPF 511 establishes the external user tunnel with external data system 515 over internet 513 based on the context—including the internet address.

UE 501 and EDS 515 exchange cryptography information over the data bearer and the external user tunnel to establish cryptography keys. UE 501 establishes the encryption with EDS 515. UE 501 signals AMF 508 over 5GNR AN 502 to indicate that encryption has been established over the data bearer and the external user tunnel. In UE 501, TPM 523 may authenticate itself to AMF 508 and attest to the integrity of the software in UE 501 that provides the encryption indication. AMF 508 validates the encryption notification based on the authentication and attestation. AMF 508 does not remove the restriction unless the encryption notification is valid.

In response to the encryption, AMF 508 and SMF 511 interact to develop additional context that removes the communication restriction from the data bearer. SMF 511 transfers additional context to UPF 511. AMF 508 transfers additional context to 5GNR AN 502. AMF 508 transfers additional context to UE 501 over 5GNR AN 502. In response to the additional context, UE 501 and EDS 515 exchange encrypted user data over the data bearer and the external user tunnel. For example, UE 501 may transfer encrypted messages to EDS 515 which decrypts the messages and transfers them to their destinations.

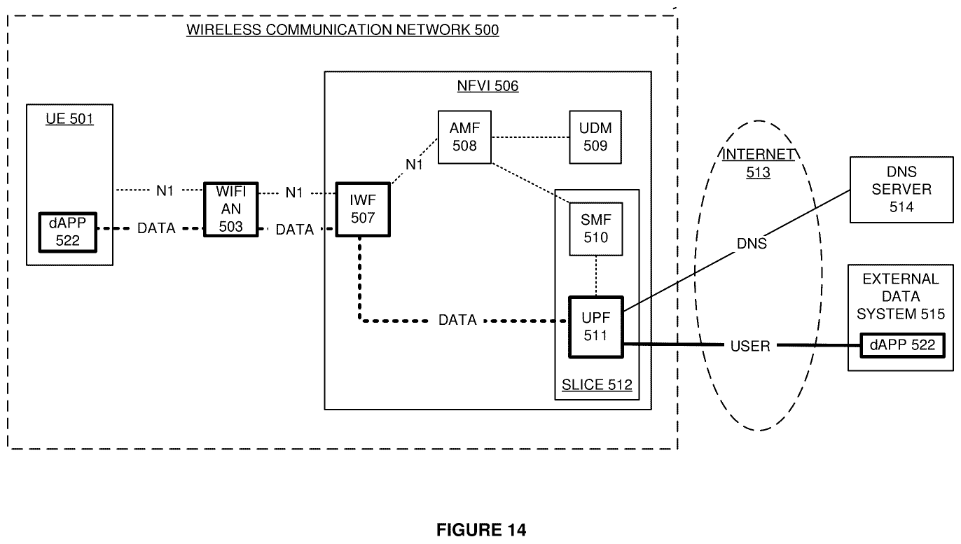

FIG. 14 illustrates exemplary wireless communication network 500 to serve wireless UE 501 with the encrypted data bearer, encrypted DNS tunnel, and encrypted user tunnel over WIFI AN 503. The operation may differ in other examples. UE 501 and AMF 508 exchange N1 signaling over an N1 signaling link that traverses WIFI AN 503 and IWF 507. UE 501 and UPF 511 exchange encrypted DNS information over a data bearer (DATA) that traverses WIFI AN 503 and IWF 507. UPF 511 and DNS server 514 exchange the encrypted DNS information over an external DNS tunnel (DNS) that traverses internet 513. The external DNS tunnel encapsulates the encrypted DNS information. The external DNS tunnel may be omitted in some examples. DNS server 514 may be internal to wireless communication network 500 in some examples.

UE 501 and UPF 511 exchange encrypted user data over the data bearer that traverses WIFI AN 503 and IWF 507. UPF 511 and EDS 515 exchange the encrypted user data over an external user tunnel (USER) that traverses internet 513. The external user tunnel encapsulates the encrypted user data. The external user tunnel may be omitted in some examples. In UE 501, dAPP 522 exchanges encrypted dAPP data with dAPP 522 in EDS 515. UE 501 and UPF 511 implement integrity protection to ensure that the encrypted DNS information and the encrypted user data are not tampered with in wireless communication network 500. UE 501 or UPF 511 may implement integrity protection with DNS 514 and EDS 515 for the external DNS tunnel and the external user tunnel.

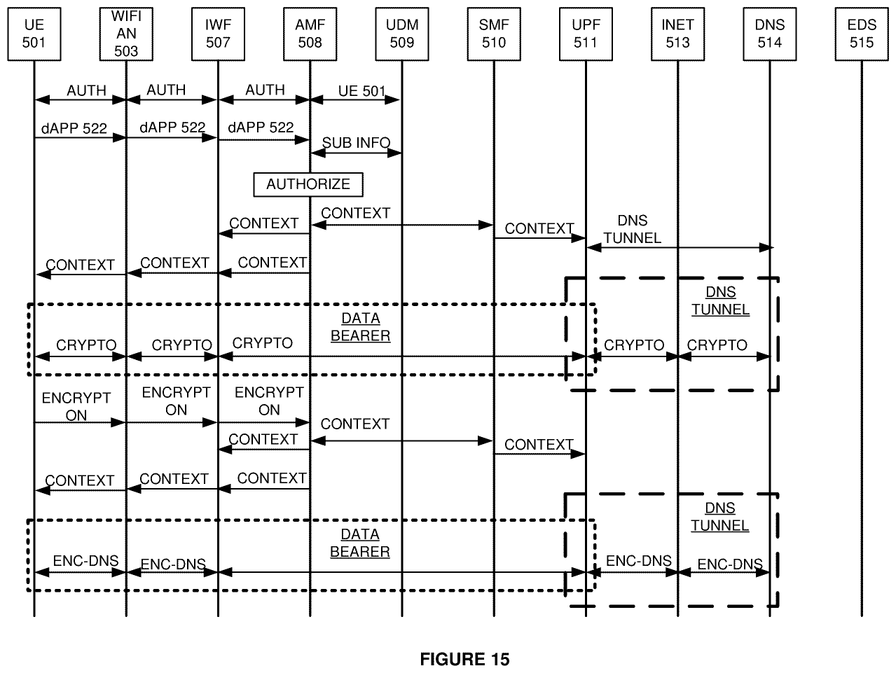

FIG. 15 illustrates an exemplary operation of wireless communication network 500 to serve wireless UE 501 with the encrypted data bearer, encrypted DNS tunnel, and encrypted user tunnel over WIFI AN 503. The operation may differ in other examples. To authenticate UE 501, AMF 508 and UE 501 exchange authentication signaling (AUTH) over WIFI AN 503 and IWF 507. AMF 508 retrieves authentication information for UE 501 from UDM 509. AMF 508 authenticates UE 501 based on the authentication information and the signaling. In particular, AMF 508 transfers an authentication challenge to UE 501 over IWF 507 and WIFI AN 503. UE 501 uses a secret key to respond to AMF 508, and AMF 508 verifies this secret key based on the authentication information.

After authentication, UE 501 indicates dAPP 522 to AMF 508 over 5GNR AN 502. UE 501 may indicate dAPP 522 by indicating a dAPP type, or some other application information. AMF 508 retrieves subscriber information for UE 501 from UDM 509. AMF 508 authorizes UE 501 for dAPP 522 based on the subscriber information. The subscriber information for dAPP 522 indicates the following data links to give UE 501: 1) a data bearer between UE 501 and UPF 511, 2) an external DNS tunnel between UPF 511 and external DNS server 514, and 3) a user tunnel between UPF 511 and an internet address for EDS 515 to be supplied by UE 501.

AMF 508 authorizes UE 501 for the data bearer, DNS tunnel, and user tunnel based on the subscriber information. AMF 508 and SMF 511 interact to develop context for the data bearer, the external DNS tunnel, and the external user tunnel based on the subscriber information. The context includes network addresses, service qualities, and the like. The context for the data bearer restricts initial use to network control and encryption establishment. The restriction is removed for DNS information when encryption is established over the data bearer and the external DNS tunnel. The restriction is removed for user data when encryption is established over the data bearer and the external user tunnel. SMF 511 transfers context to UPF 511. AMF 508 transfers context to IWF 507. AMF 508 transfers context to UE 501 over IWF 507 and WIFI AN 503. UE 501 and IWF 507 establish part of the data bearer based on the context. IWF 507 and UPF 511 establish the other part of the data bearer based on the context. UPF 511 establishes the external DNS tunnel with external DNS server 514 over internet 513 based on the context.

The subscriber information for UE 501 may indicate DNS server 514 for UE 501 and/or dAPP 522. Alternatively, UE 501 may indicate DNS server 514 to AMF 508, and AMF 508 may authorize DNS server 514 based on the subscriber information for UE 501. For example, the subscriber information may include a list of allowable DNS names that network 500 can translate into the appropriate DNS addresses. The context carries the DNS address to UPF 511 for DNS tunnel establishment.

Except for network control and encryption establishment, IWF 507 and/or UPF 511 block other communications over the data bearer per the context. UE 501 and DNS server 514 exchange cryptography information (CRYPTO) over the data bearer and the external DNS tunnel to establish cryptography keys. In UE 501, TPM 523 provides the keys to establish the encryption with DNS server 514. UE 501 signals AMF 508 over WIFI AN 503 and IWF 507 to indicate that encryption has been established over the data bearer and the external DNS tunnel. AMF 508 validates the encryption notification, and AMF 508 does not remove the restriction unless the notification is valid. For example, TPM 523 may provide a hash of its hardware identifier, and AMF 508 may authenticate TPM 523 based on the hash. TPM 523 monitors boot records and attests to the integrity of the software in UE 501. The encryption notification is from this attested software, and AMF 508 validates the encryption indication because the attested software provided the notification. AMF 508 and SMF 511 interact to develop additional context that removes the communication restriction from the data bearer when using the external DNS tunnel. SMF 511 transfers the additional context to UPF 511. AMF 508 transfers additional the context to IWF 507. AMF 508 transfers the additional context to UE 501 over IWF 507 and WIFI AN 503.

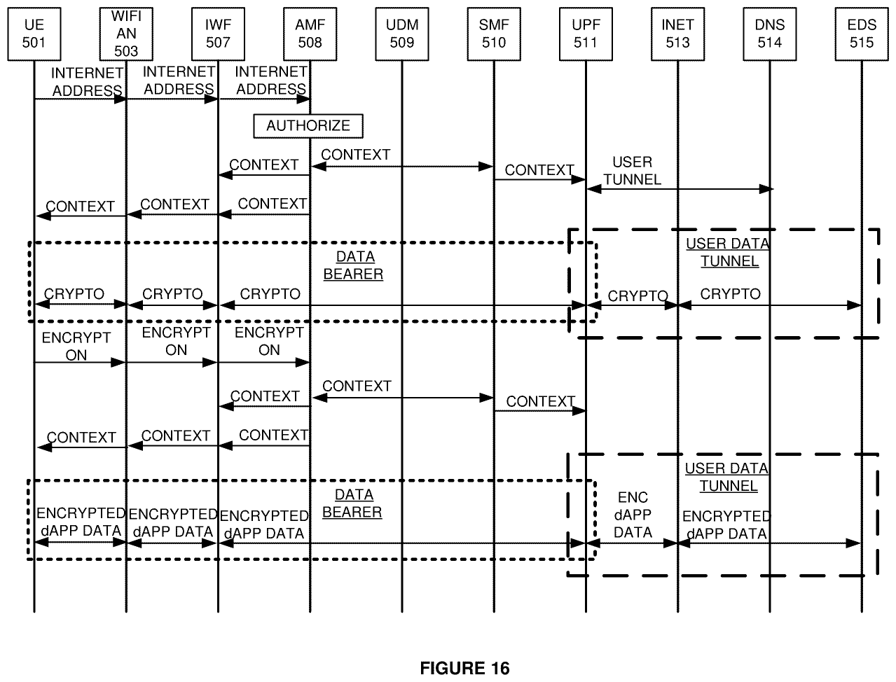

In response to the additional context, UE 501 and DNS server 514 exchange encrypted DNS information (ENC-DNS). In particular, UE 501 encrypts a domain name for EDS 515 and transfers the encrypted domain name to DNS server 514 over the data bearer and the external DNS tunnel that traverse WIFI AN 503, IWF 507, UPF 511, and internet 513. DNS server 514 decrypts the encrypted domain name. DNS server 514 translates the domain name into an internet address for EDS 515. DNS server 514 encrypts and transfers the internet address and a digital certificate to UE 501 over the external DNS tunnel and the data bearer that traverse internet 513, UPF 511, IWF 507, and WIFI AN 503. UE 501 receives and decrypts the encrypted internet address and the digital certificate. UE 501 validates the digital certificate with a public key for external DNS server 514 and only uses the internet address when the digital certificate is valid. The operation continues on FIG. 16 below.

FIG. 16 further illustrates the exemplary operation of wireless communication network 500 to serve wireless UE 501 with the encrypted data bearer, encrypted DNS tunnel, and encrypted user tunnel over WIFI AN 503. The operation continues from FIG. 15 above and may differ in other examples. UE 501 indicates the internet address for the user tunnel to AMF 508 over WIFI AN 503 and IWF 507. In UE 501, TPM 523 may authenticate itself to AMF 508 and attest to the integrity of the software in UE 501 that transferred the internet address. AMF 508 validates the internet address indication based on the authentication and attestation, and AMF 508 does not use the internet address unless the indication is valid. AMF 508 and SMF 511 interact to develop context for the external user tunnel. SMF 511 transfers context which includes the internet address to UPF 511. AMF 508 transfers context to IWF 507. AMF 508 transfers context to UE 501 over IWF 507 and WIFI AN 503. UPF 511 establishes the external user tunnel with external data system 515 over internet 513 based on the context.

UE 501 and EDS 515 exchange cryptography information (CRYPTO) over the data bearer and the external user tunnel to establish cryptography keys. In UE 501, TPM 523 provides the keys to establish the encryption with EDS 515. UE 501 signals AMF 508 over WIFI AN 503 and IWF 507 to indicate that encryption has been established over the data bearer and external user tunnel. TPM 523 may authenticate itself to AMF 508 and attest to the integrity of the software in UE 501 that provides the encryption indication. AMF 508 validates the encryption indication based on the authentication and attestation, and AMF 508 does not remove the restriction unless the notification is valid. In response, AMF 508 and SMF 511 interact to develop additional context that removes the communication restriction from the data bearer when using the external user tunnel. SMF 511 transfers additional context to UPF 511. AMF 508 transfers additional context to IWF 507. AMF 508 transfers additional context to UE 501 over IWF 507 and WIFI AN 503. In response to the additional context, UE 501 and EDS 515 exchange encrypted dAPP data over the data bearer and the external user tunnel. For example, dAPP 522 in UE 501 and dAPP 522 in EDS 515 may exchange encrypted financial information between a user and their bank.

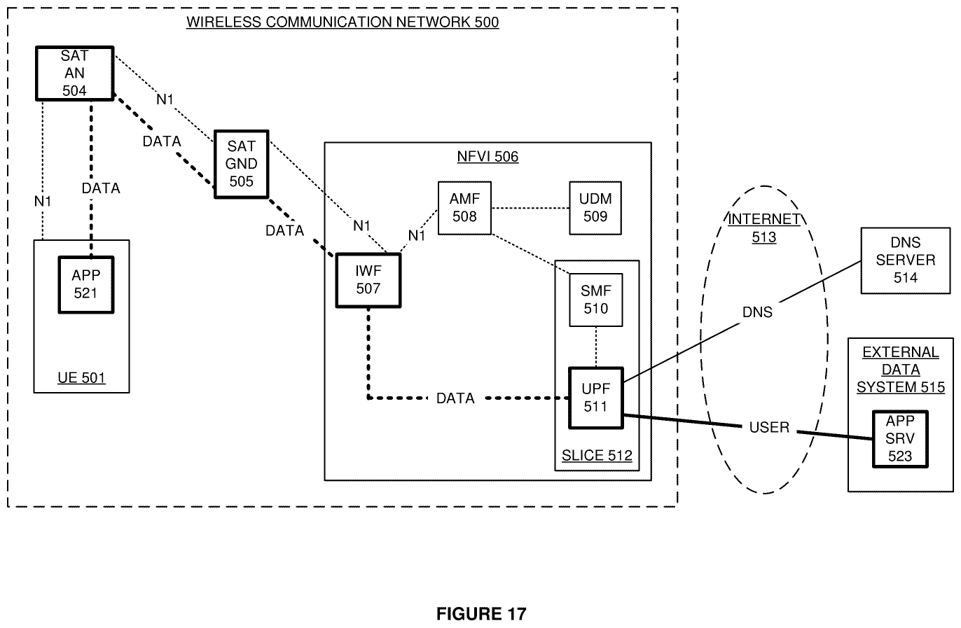

FIG. 17 illustrates exemplary wireless communication network 500 to serve wireless UE 501 with the encrypted data bearer, encrypted DNS tunnel, and encrypted user tunnel over SAT AN 503. The operation may differ in other examples. UE 501 and AMF 508 exchange N1 signaling over an N1 signaling link that traverses SAT AN 504, SAT GND 505, and IWF 507. UE 501 and UPF 511 exchange encrypted DNS information over a data bearer that traverses SAT AN 504, SAT GND 505, and IWF 507. UPF 511 and DNS server 514 exchange the encrypted DNS information over an external DNS tunnel that traverses internet 513. The external DNS tunnel encapsulates the encrypted DNS information. The external DNS tunnel may be omitted in some examples. UE 501 and UPF 511 exchange encrypted user data over the data bearer that traverses SAT AN 504, SAT GND 505, and IWF 507. UPF 511 and EDS 515 exchange the encrypted user data over an external user tunnel that traverses internet 513. The external user tunnel encapsulates the encrypted user data. The external user tunnel may be omitted in some examples. EDS 515 may be internal to wireless communication network 500 in some examples. User Application (APP) 521 in UE 501 exchanges APP data with Application Server (APP SRV) 524 in EDS 515. UE 501 and UPF 511 implement integrity protection to ensure that the encrypted DNS information and the encrypted user data are not tampered with in wireless communication network 500. UE 501 or UPF 511 may implement integrity protection with DNS 514 and EDS 515 for the external DNS tunnel and the external user tunnel.

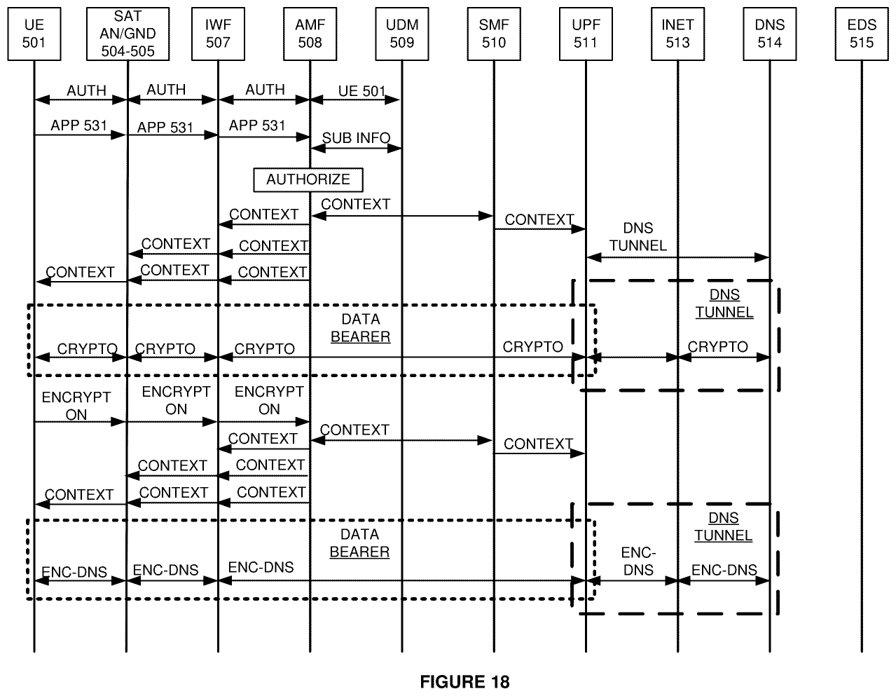

FIG. 18 illustrates an exemplary operation of wireless communication network 500 to serve wireless UE 501 with the encrypted data bearer, encrypted DNS tunnel, and encrypted user tunnel over SAT AN 504. The operation may differ in other examples. To authenticate UE 501, AMF 508 and UE 501 exchange authentication signaling (AUTH) over SAT AN 504, SAT GND 505, and IWF 507. AMF 508 retrieves authentication information for UE 501 from UDM 509. AMF 508 authenticates UE 501 based on the authentication information and the signaling. In particular, AMF 508 transfers an authentication challenge to UE 501 over IWF 507, SAT GND 505, and SAT AN 505. UE 501 uses a secret key to respond to AMF 508, and AMF 508 verifies this secret key based on the authentication information.

After authentication, UE 501 indicates User Application (APP) 521 to AMF 508 over SAT AN 504, SAT GND 505, and IWF 507. UE 501 may indicate APP 521 by indicating an APP type or some other application information. AMF 508 retrieves subscriber information for UE 501 from UDM 509. AMF 508 authorizes UE 501 for APP 521 based on the subscriber information. The subscriber information for APP 521 indicates the following for UE 501: 1) a data bearer between UE 501 and UPF 511, 2) an external DNS tunnel between UPF 511 and external DNS server 514, and 3) a user tunnel between UPF 511 and an internet address for EDS 515 to be supplied by UE 501.

AMF 508 authorizes UE 501 for the data bearer, DNS tunnel, and user tunnel based on the subscriber information. AMF 508 and SMF 511 interact to develop context for the data bearer, the external DNS tunnel, and the external user tunnel based on the subscriber information. The context includes network addresses, service qualities, and the like. The context for the data bearer restricts initial use to network control and encryption establishment. The restriction is removed for DNS information when encryption is established over the data bearer and the external DNS tunnel. The restriction is removed for user data when encryption is established over the data bearer and the external user tunnel. SMF 511 transfers context to UPF 511. AMF 508 transfers context to IWF 507. AMF 508 transfers context to SAT AN 504 over IWF 507 and SAT GND 505. AMF 508 transfers context to UE 501 over IWF 507, SAT GND 505, and SAT AN 504. UE 501 and IWF 507 establish part of the data bearer based on the context. IWF 507 and UPF 511 establish the other part of the data bearer based on the context. UPF 511 establishes the external DNS tunnel with external DNS server 514 over internet 513 based on the context.

The subscriber information for UE 501 may indicate DNS server 514 for UE 501 and/or application 521. Alternatively, UE 501 may indicate DNS server 514 to AMF 508, and AMF 508 may authorize DNS server 514 based on the subscriber information for UE 501. For example, the subscriber information may include a list of allowable DNS names that network 500 can translate into the appropriate DNS addresses, and UE 501 may provide one of those allowed names. The context carries this DNS address to UPF 511 for DNS tunnel establishment.

Except for network control and encryption establishment, SAT AN 504, IWF 507 and/or UPF 511 block other communications over the data bearer per the context. UE 501 and DNS server 514 exchange cryptography information (CRYPTO) over the data bearer and the external DNS tunnel to establish cryptography keys. In UE 501, TPM 523 provides the keys to establish the encryption with DNS server 514. UE 501 signals AMF 508 over SAT AN 504. SAT GND 505, and IWF 507 to indicate that encryption has been established over the data bearer and the external DNS tunnel. In UE 501, TPM 523 authenticates itself to AMF 508 and attests to the integrity of the software that notifies AMF 508 that encryption has been established over the data bearer and the external DNS tunnel. AMF 508 validates the encryption notification based on the authentication and attestation, and AMF 508 does not remove the restriction unless the notification is valid. AMF 508 and SMF 511 interact to develop additional context that removes the communication restriction from the data bearer when using the external DNS tunnel. SMF 511 transfers the additional context to UPF 511. AMF 508 transfers the additional context to IWF 507. AMF 508 transfers the additional context to SAT AN 504 over IWF 507 and SAT GND 505. AMF 508 transfers the additional context to UE 501 over IWF 507, SAT GND 505, and SAT AN 504.

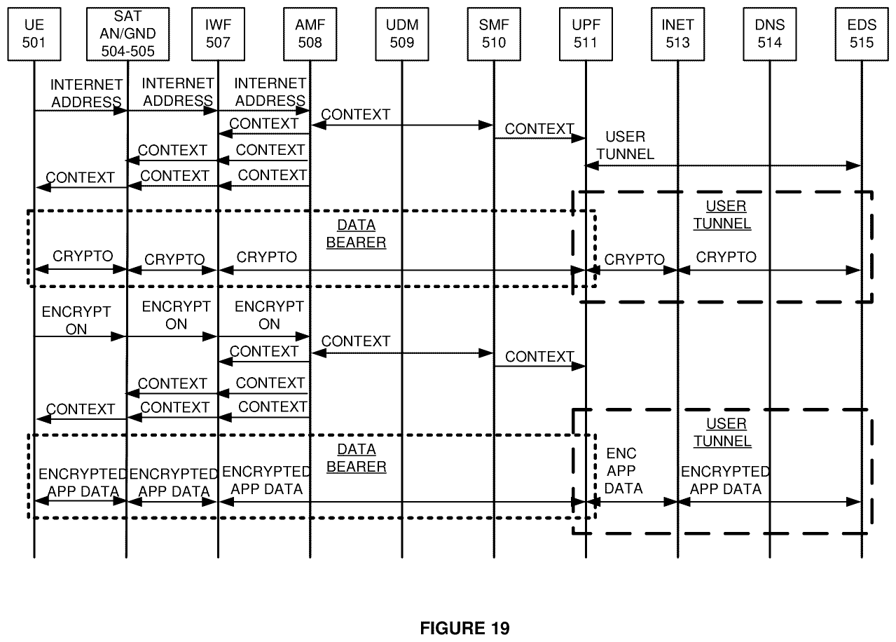

In response to the additional context, UE 501 and DNS server 514 exchange encrypted DNS information (ENC-DNS). In particular, UE 501 encrypts a domain name for EDS 515 and transfers the encrypted domain name to DNS server 514 over the data bearer and the external DNS tunnel that traverses SAT AN 504, SAT GND 505, IWF 507, UPF 511, and internet 513. DNS server 514 decrypts the encrypted domain name. DNS server 514 translates the domain name into an internet address for EDS 515. DNS server 514 encrypts and transfers the internet address and a digital certificate to UE 501 over the external DNS tunnel and the data bearer that traverse internet 513, UPF 511, IWF 507, SAT GND 505, and SAT AN 504. UE 501 receives and decrypts the encrypted internet address and the digital certificate. UE 501 validates the digital certificate with a public key for external DNS server 514 and only uses the internet address when the digital certificate is valid. The operation continues on FIG. 19 below.

FIG. 19 further illustrates the exemplary operation of wireless communication network 500 to serve wireless UE 501 with the encrypted data bearer, encrypted DNS tunnel, and encrypted user tunnel over SAT AN 504. The operation continues from FIG. 18 above and may differ in other examples. UE 501 indicates the internet address for the user tunnel to AMF 508 over SAT AN 504, SAT GND 505, and IWF 507. AMF 508 validates the internet address indication, and AMF 508 does not use the internet address unless the indication is valid. AMF 508 may validate the internet address validating a digital certificate from UE 501 or by verifying the attestation of integrity from TPM 523 for the software in UE 501 that provides the internet address. AMF 508 and SMF 511 interact to develop context for the external user tunnel. SMF 511 transfers context which includes the internet address to UPF 511. AMF 508 transfers context to IWF 507. AMF 508 transfers context to UE 501 over IWF 507, SAT GND 505, and SAT AN 504. UPF 511 establishes the external user tunnel with external data system 515 over internet 513 based on internet address in the context.

UE 501 and EDS 515 exchange cryptography information (CRYPTO) over the data bearer and the external user tunnel to establish cryptography keys. In UE 501, TPM 523 provides the keys to establish the encryption with EDS 515. UE 501 signals AMF 508 over SAT AN 504, SAT GND 505, and IWF 507 to indicate that encryption has been established over the data bearer and external user tunnel. In UE 501, TPM 523 authenticates itself to AMF 508 and attests to the integrity of the software in UE 501 that notifies AMF 508 that encryption has been established over the data bearer and the external user tunnel. AMF 508 validates the encryption notification based on the authentication and attestation, and AMF 508 does not remove the restriction unless the notification is valid. In response, AMF 508 and SMF 511 interact to develop additional context that removes the communication restriction from the data bearer when using the external user tunnel. SMF 511 transfers additional context to UPF 511. AMF 508 transfers additional context to IWF 507. AMF 508 transfers additional context to UE 501 over IWF 507, SAT GND 505, and SAT AN 504. In response to the additional context, UE 501 and EDS 515 exchange encrypted APP data over the data bearer and the external user tunnel. For example, APP 531 in UE 501 and APP SRV 534 in EDS 515 may exchange software requests and downloads.

Advantageously, wireless communication network 500 efficiently and effectively implements end-to-end encryption across the network for user data. Moreover, wireless communication network 500 mitigates network security risks for its users. Thus, wireless communication network 500 represents a zero-trust network that efficiently and effectively serves wireless UE 501.

The wireless communication system circuitry described above comprises computer hardware and software that form special-purpose data communication circuitry to provide a wireless communication device with an encrypted data bearer. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry system to provide a wireless communication device with an encrypted data bearer.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
establishing a data bearer through a wireless communication network for a wireless communication device;
restricting communications over the data bearer to network control and encryption establishment;
to establish the encryption, exchanging cryptography data between the wireless communication device and an external security service over the data bearer, wherein the external security service is external to the wireless communication network; and
determining that the wireless communication device and the external security service have established the encryption over the data bearer, and in response, removing the communication restriction from the data bearer and exchanging encrypted data over the data bearer between the wireless communication device and the external security service.

2. The method of claim 1 further comprising:
to establish the encryption, transferring translation data over the data bearer between the wireless communication device and an external translation system; and wherein
the translation data transferred from the wireless communication device to the external translation system indicates a name for the external security service, the external translation system translates the name into a network address for the external security service, and the translation data transferred from the external translation system to the wireless communication device indicates the network address for the external security service, wherein the external translation system is external to the wireless communication network.

3. The method of claim 1 further comprising:
to establish the encryption, exchanging translation data over the data bearer between the wireless communication device and an external translation system, wherein the translation data from the external translation system to the wireless communication device indicates a digital certificate for the external translation system and a network address for the external security service; and
to establish the encryption, validating the digital certificate, and in response to the validation, using the network address to establish the encryption over the data bearer with the external security service.

4. The method of claim 1 further comprising:
receiving slice information from the wireless communication device; and wherein
establishing the data bearer through the wireless communication network comprises
establishing the data bearer through a wireless network slice based on the slice information;
restricting the communications over the data bearer comprises restricting the communications over the data bearer through the wireless network slice;
exchanging the cryptography data over the data bearer comprises exchanging the cryptography data over the data bearer through the wireless network slice;
determining that the wireless communication device and the external security service have established the encryption over the data bearer comprises determining that the wireless communication device and the external security service have established the encryption over the data bearer through the wireless network slice; and
removing the communication restriction from the data bearer and exchanging the encrypted data over the data bearer comprises removing the communication restriction from the data bearer through the wireless network slice and exchanging the encrypted data over the data bearer through the wireless network slice.

5. The method of claim 1:
establishing the data bearer through the wireless communication network comprises establishing the data bearer for a user application in the wireless communication device;
restricting communications over the data bearer to the network control and the encryption establishment comprises restricting the communications for the user application; and
exchanging the encrypted data over the data bearer comprises exchanging the encrypted data for the user application.

6. The method of claim 1:
establishing the data bearer through the wireless communication network comprises establishing the data bearer for a distributed Application (dAPP) in the wireless communication device and in the external security service;
restricting the communications over the data bearer to the network control and the encryption establishment comprises restricting the communications between the dAPP in the wireless communication device and the dAPP in the external security service; and
exchanging the encrypted data over the data bearer comprises exchanging the encrypted data between the dAPP in the wireless communication device and the dAPP in the external security service.

7. The method of claim 1 further comprising:
establishing an external data tunnel from the data bearer in the wireless communication network to the external security service; and wherein
exchanging the encrypted data over the data bearer between the wireless communication device and the external security service comprises exchanging the encrypted data over the external data tunnel.

8. A method comprising:
authenticating a wireless communication device;
in response to the authentication, authorizing the wireless communication device to use a data bearer in a wireless communication network, an external DNS tunnel from the data bearer to an external DNS server, and an external user tunnel from the data bearer to an external user data system;
in response to the authorization, establishing the data bearer in the wireless communication network and establishing the external DNS tunnel from the data bearer to the external DNS server;
exchanging encrypted DNS information between the wireless communication device and an external DNS server over the data bearer and the external DNS tunnel; and
receiving a network address for the external data system from the wireless communication device, and in response, establishing the user tunnel from the data bearer to the external user data system; and
exchanging encrypted user data between the wireless communication device and the external user data system over the data bearer and the external user tunnel.

9. The method of claim 8 wherein:
authorizing the wireless communication device to use the data bearer comprises authorizing the wireless communication device to use a wireless network slice;
establishing the data bearer comprises establishing the data bearer through the wireless network slice; and
exchanging the encrypted DNS information and the encrypted user data comprises exchanging the encrypted DNS information and the encrypted user data over the wireless network slice.

10. The method of claim 8 wherein:
authorizing the wireless communication device to use the data bearer comprises authorizing the wireless communication device to use a user application; and
exchanging the encrypted user data over the data bearer comprises exchanging the encrypted user data between the user application and the external user data system.

11. The method of claim 8 wherein exchanging the encrypted DNS information over the data bearer comprises transferring an encrypted domain name from the wireless communication device to the external DNS server and transferring an encrypted network address from the external DNS server to the wireless communication device.

12. The method of claim 8 wherein:
exchanging the encrypted DNS information over the data bearer comprises transferring an encrypted domain name from the wireless communication device to the external DNS server and transferring a digital certificate and an encrypted network address from the external DNS server to the wireless communication device; and
the wireless communication device validates the digital certificate, and in response, uses the network address from the external DNS server when the digital certificate is valid.

13. The method of claim 8 wherein:
exchanging the encrypted DNS information between the wireless communication device and the external DNS server over the data bearer comprises wirelessly exchanging the encrypted DNS information over a Wireless Fidelity (WIFI) link; and
exchanging the encrypted user data between the wireless communication device and the external user data system over the data bearer comprises wirelessly exchanging the encrypted user data over the WIFI link.

14. The method of claim 8 wherein:
exchanging the encrypted DNS information between the wireless communication device and the external DNS server over the data bearer comprises wirelessly exchanging the encrypted DNS information over a satellite link; and
exchanging the encrypted user data between the wireless communication device and the external user data system over the data bearer comprises wirelessly exchanging the encrypted user data over the satellite link.

15. A wireless communication network comprising:
a network control system to establish a data bearer through a wireless communication network for a wireless communication device;
the network control system to restrict communications over the data bearer to network control and encryption establishment;
a network element to exchange cryptography data over the data bearer between the wireless communication device and an external security service;
the network control system to determine that the wireless communication device and the external security service have established the encryption over the data bearer, and in response, to remove the communication restriction from the data bearer; and
after the communication restriction is removed, the network element to exchange encrypted data over the data bearer between the wireless communication device and the external security service.

16. The wireless communication network of claim 15 further comprising:
the network element to transfer translation data over the data bearer between the wireless communication device and an external translation system; and wherein
the translation data transferred from the wireless communication device to the external translation system indicates a name for the external security service, the external translation system translates the name into a network address for the external security service, and the translation data transferred from the external translation system to the wireless communication device indicates the network address for the external security service.

17. The wireless communication network of claim 15 further comprising:
the network element to exchange translation data over the data bearer between the wireless communication device and an external translation system, wherein the translation data from the external translation system to the wireless communication device indicates a digital certificate for the external translation system and a network address for the external security service; and wherein
the wireless communication device is to validate the digital certificate, and in response to the validation, use the network address to establish the encryption with the external security service over the encrypted data bearer.

18. The wireless communication network of claim 15 further comprising:
the network control system to receive slice information from the wireless communication device; and wherein
the network control system is to establish the data bearer through a wireless network slice based on the slice information;
the network control system to restrict the communications over the data bearer through the wireless network slice to the network control and encryption establishment;
the network element to exchange the cryptography data over the data bearer through the wireless network slice;
the network control system to determine that the wireless communication device and the external security service have established the encryption over the data bearer through the wireless network slice;
the network control system to remove the communication restriction from the data bearer through the wireless network slice; and
after the communication restriction is removed, the network element to exchange the encrypted data over the data bearer through the wireless network slice.

19. The wireless communication network of claim 15 wherein:
the network control system is to establish the data bearer for a user application in the wireless communication device;
the network control system is to restrict the communications for the user application to the network control and the encryption establishment; and
after the communication restriction is removed, the network element is to exchange the encrypted data over the data bearer for the user application.

20. The wireless communication network of claim 15 wherein:
the network control system is to establish the data bearer for a distributed Application (dAPP) in the wireless communication device and in the external security service;
the network control system is to restrict the communications over the data bearer between the dAPP in the wireless communication device and the dAPP in the external security service to the network control and encryption establishment; and
after the communication restriction is removed, the network element is to exchange the encrypted data over the data bearer between the dAPP in the wireless communication device and the dAPP in the external security service.
